(19) United States
(12) Patent Application Publication
(10) Pub. No.: US 2020/0212533 A1
(43) Pub. Date: Jul. 2, 2020

(54) FOLDABLE PANEL ANTENNA

(71) Applicant: SHENZHEN 1BYONE TECHNOLOGY CO., LTD., Shenzhen (CN)

(72) Inventor: Ruishi YANG, Shenzhen (CN)

(21) Appl. No.: 16/296,756

(22) Filed: Mar. 8, 2019

(30) Foreign Application Priority Data
Dec. 28, 2018 (CN) 201822240058.X

(51) Int. Cl. H01Q 1/08; H01Q 19/04

(52) U.S. Cl. CPC H01Q 1/08; H01Q 19/04

(57) ABSTRACT

The present invention relates to a foldable panel antenna which comprising a main body including a first vibrator, a first housing coating the first vibrator, and a feeder terminal; at least one side plate including a second vibrator and a second housing coating the second vibrator; and a rotating mechanism which is designed to connect the main body and the side plate and rotate the side plate around the main body, and the first vibrator is in electric connection with the second vibrator at the rotating mechanism. The foldable panel antenna can achieve the effects of compatibly receiving VHF/UHF signals, being easy to store, carry and transport, and effectively controlling the cost.

### TECHNICAL FIELD

The present invention relates to the technical field of panel antenna, and in particular to a foldable panel antenna.

### BACKGROUND OF THE INVENTION

Panel television antennas are mainly applied for indoor signals reception of broadcast or television, and have been widely used in home life and other fields. More and more people purchase and use thin-sheet panel antennas especially with the popularization of the thin-sheet panel antenna technology. This kind of thin-sheet panel antenna has quickly occupied a large part of the market because of small size, and thin thickness, and convenient to transport and install. However, since the current TV panel antenna can usually only be fixed at one angle, the antenna can only well receive the signal in the direction of facing the panel antenna but cannot well receive the signal which is not in the direction of facing the panel antenna. Alternatively, the entire panel antenna needs to be moved to adjust the angle to achieve better signal reception, so that the position of reinstalling and fixing the panel antenna needs to be adjusted, which is not easy to operate.

### SUMMARY OF THE INVENTION

It is therefore an object of the present invention to overcome at least one of the above-mentioned deficiencies in the background, and to provide a foldable panel antenna to solve the problems existing in thin-sheet panel antenna product currently on the market, such as limited receiving angles, with only one fixed angle and failure to receive VHF signals which can achieve the effects of compatibly receiving VHF/UHF signals, being easy to store, carry and transport, and effectively controlling the cost.

A foldable panel antenna according to the present invention comprises a main body including a first vibrator, a first housing coating the first vibrator, and a feeder terminal; at least one side plate including a second vibrator and a second housing coating the second vibrator; and a rotating mechanism which is designed to connect the main body and the side plate and rotate the side plate around the main body, and the first vibrator is in electric connection with the second vibrator at the rotating mechanism.

In the above technical solution, the panel antenna is configured to comprise a main body including a first vibrator, a first housing coating the first vibrator, and a feeder terminal; at least one side plate including a second vibrator and a second housing coating the second vibrator; and a rotating mechanism, wherein the main body is connected to the side plate through the rotating mechanism to realize rotation of the side plate around the main body, and the first vibrator is in electric connection with the second vibrator at the rotating mechanism.

Preferably, the side plate is configured with two which are asymmetrically distributed on both sides of the main body.

With such arrangement of the side plate, the television can receive signals well by rotating the two side plates, without the need to move the main body of the panel antenna, to right face the source of the television signal to be received to make the receiving surface larger. In addition, the VHF signal can be better received as a large width exists between the two side plates and the main body of the panel antenna.

Preferably, the main body can be in a rectangular form, in a circular form or centrally symmetric polygon, and the side plate can be configured with more than one, which are centrosymmetrically distributed around the main body.

The main body is a rectangular shape, circular shape or centrally symmetric polygon, the side plate has more than one centrosymmetrically distributed around the main body, and each side plate is connected to the main body through a rotating mechanism, so that the angles of the side plates of the panel antenna can be adjusted in multiple directions, thereby obtaining more signals in different directions, so as to achieve optimal combination of the signal sources, and finally realizing the enhancement and optimization of the panel antenna signal.

The first housing and the second housing both have double-layer panel structures. The first housing is divided into a first front housing and a first rear housing. The first vibrator is clamped in an interlayer formed by the first front housing and the first rear housing. The second housing is divided into a second front housing and a second rear housing. The second vibrator is clamped in an interlayer formed by the second front housing and the second rear housing.

The first housing and the second housing are both configured with double-layer panel structures, and the first vibrator and the second vibrator are respectively clamped in the interlayers of the first housing and the second housing, so that the whole panel antenna has small size, thin thickness, and light weight, is convenient to transport and install, and takes less transportation cost.

Preferably, the first housing is in double-layer panel structure and divided into a first front housing and a first rear housing. The first vibrator is clamped in the interlayer formed by the first front housing and the first rear housing. The second housing is in a groove structure including a groove base and a cover plate. The second vibrator is clamped in an interlayer formed by the groove base and the cover plate.

The second housing can be designed with a groove structure, and the second vibrator is clamped in the interlayer formed by the groove base and the cover plate.

Preferably, the first housing has a double-layer panel structure. The first housing is divided into a first front housing and a first rear housing. The first vibrator is clamped in the interlayer formed by the first front housing and the first rear housing. The second housing has a double-groove structure including a groove base, a front cover plate and a rear cover plate, and the groove base is provided with a front groove and a rear groove. The second vibrator is divided into a second front vibrator and a second rear vibrator. The second front vibrator is clamped in an interlayer formed by the front groove and the front cover plate, and the second rear vibrator is clamped in an interlayer formed by the rear groove and the rear cover plate.

The second housing has a double-groove structure, the second vibrator is divided into a second front vibrator and a second rear vibrator, and the second front vibrator and the second rear vibrator are respectively clamped in the front groove and the rear groove. Therefore, both sides of the side plate can receive signals. When one surface of the active page of the panel antenna cannot receive signals due to a fault, or the signal reception is poor, such surface can be removed and the other surface without a fault can be installed and used by rotating 180°, thus further improving the utilization of the panel antenna.

Preferably, the side plate is configured with four, the area of the main body is greater than or equal to a sum of areas of the side plate, and an area of each of four side plates is less than or equal to a quarter of the area of the main body, so that the side plate will not overlap with one another when folded.

The four side plates with the area of each side plate is less than or equal to a quarter of the area of the main body and the area of the main body is greater than or equal to a sum of areas of the side plates. Accordingly, when needs to be stored, the side plate will be folded up, and each side plate may not overlap and not exceed the size of the main body, making it more convenient to carry and more aesthetic quality.

Preferably, the second housing only coats the second vibrator outside in form of a grid structure.

In the present invention, the side plate is configured in a grid structure and the second housing only surrounds the second vibrator. Since the active vibrator or passive vibrator for the panel antenna to receive signal are generally configured into a plurality of strip structures in parallel arrangement, which refers to the principle of the Yagi panel antenna, the panel antenna in the present technical solution only coats the housing at the active vibrator or the passive vibrator to form a grid structure. And the groove and the cover plate of the second housing are both have a grid structure and clamp the outside of the second vibrator. Such arrangement of the grid structure can save material and cost and reduce the weight of the panel antenna itself, making it lighter and more convenience to transport and carry.

The rotating mechanism is detachable. The main body is in electric connection with the side plate. The rotating mechanism includes a shaft and a plurality of bearings arranged on the main body and the side plate. The bearings are sleeved through the shaft to realize rotation. The rotating mechanism further includes a limit mechanism which can adjust an angle of the side plate relative to the main body within 0° to 180°.

The side plate and the main body are detachably connected, and can be directly assembled when in use, and the side plate can be removed when not in use, making it more convenience to transport and carry. In addition, the active page of the side plate of the antenna can be directly replaced when it needs to be repaired due to a fault without repair for the entire antenna. The rotating mechanism connecting the side plate and the main body is further provided with a limit mechanism for limiting the rotation angle of the side plate. The angle can be set according to the preferred effect range of the received signal by the antenna, and is generally set between 0° and 180°. Further, the configuration of the limit mechanism can also prevent the side plates from rotating sharply, which may shorten service life of the antenna.

The bearings on the side plate are symmetrically distributed, and the side plate also has a symmetric structure.

Preferably, the bearings on the side plate are symmetrically distributed, and the side plate has a symmetric structure for being replaced by the other side and guaranteeing that the receiving signals are maintained to have the same stability as before when replaced by the other side.

Preferably, the first vibrator can be integrated with the second vibrator.

Preferably, the first housing and the second housing may be molded using an ABS, PC or PET film.

Preferably, the electrical connection mode between the main body and the side plate can be a flexible flat-cable connection. A gap exists between the bearings, so that the flexible flat-cable crosses the shaft to realize electrical connection between the main body and the side plate.

Preferably, the bearing has a bearing seat, and the bearing seat is divided into a front bearing seat and a rear bearing seat. The bearing seat is L-shaped, and the front bearing seat and the rear bearing seat are used for clamping the first front housing and the first rear housing. Alternatively, the bearing seat is I-shaped, and the front bearing seat and the rear bearing seat are used for clamping the second front housing and the second rear housing.

Compared with the prior art, the present invention has following beneficial effects.

The present invention provides a foldable panel antenna, which has small size, and thin thickness, is convenient to transport and install, and takes less transportation cost. The VHF signal can be better received by setting two side plates to increase the overall area of the panel antenna. In addition, the angles of the panel antenna can be adjusted in multiple directions by setting a plurality of side plates, thereby obtaining more signals in different directions, so as to achieve optimal combination of the signal sources, and finally realizing the enhancement and optimization of the panel antenna signal. Both sides of the side plate can receive signals by setting the side plate as a double-groove structure, so that when one surface of the active page of the panel antenna cannot receive signals due to a fault, or the received signal is poor, the surface can be disassembled and the other surface without a fault can be installed and used by rotating 180°, thus further improving the utilization of the panel antenna. Further, the side plate and the main body are detachably connected, and can be directly assembled when in use, and the side plate can be disassembled when not in use, making it more convenient to transport and carry. Meanwhile the side plate of the antenna with active page can be directly replaced when needs to be repaired due to a fault without repair for the entire antenna. The side plate is set as a grid structure which can save material and cost and reduce the weight of the panel antenna itself, making it lighter and more convenient to transport and carry. The rotating mechanism connecting the side plate and the main body is further provided with a limit mechanism for preventing the side plates from rotating sharply and shortening service life.

Accordingly, the foldable panel antenna provided by the present invention can achieve the effects of compatibly receiving VHF/UHF signals, being easy to store, carry and transport, and effectively controlling the cost.

### BRIEF DESCRIPTION OF THE DRAWINGS

FIG. 1 is a structural schematic view of embodiment 1.

FIG. 2 is an enlarged view of a portion A of FIG. 1.

FIG. 3 is another structural schematic view of embodiment 1.

FIG. 4 is an enlarged view of a portion B of the FIG. 3.

FIG. 5 is a structural schematic view of embodiment 2.

FIG. 6 is an enlarged view of a portion C of FIG. 5.

### DESCRIPTION OF EMBODIMENTS

The drawings of the present invention are for illustration purpose only and are not intended to limit the present invention. Some components in the drawings are omitted, enlarged or reduced for better illustrating the embodiments, and sizes of these components do not represent sizes of actual product. For those skilled in the art, it will be understood that some known structures in the drawings and descriptions thereof are omitted.

### Embodiment 1

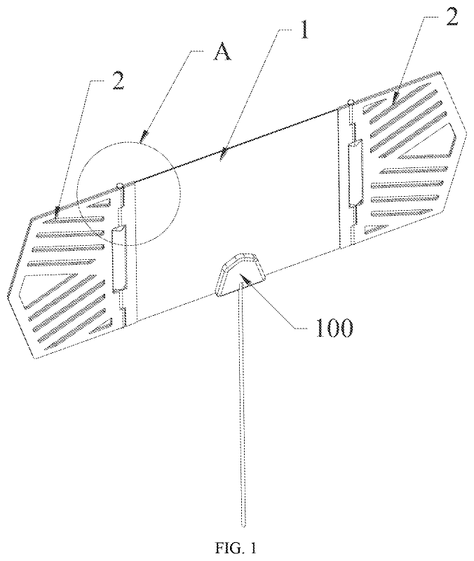

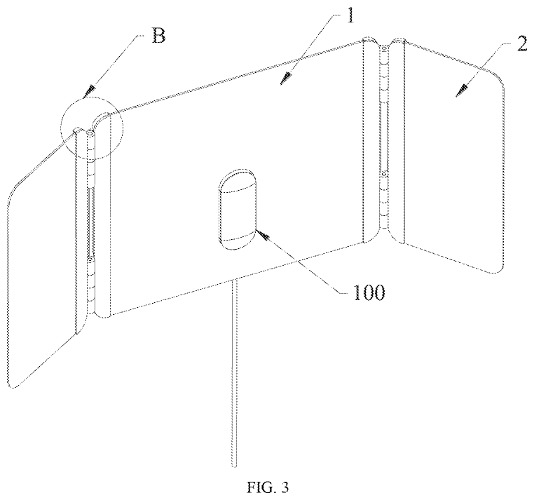

As shown in FIG. 1 or FIG. 3, a foldable panel antenna with two side plates according to the present embodiment comprises a main body 1 including a first vibrator, a first housing for coating the first vibrator, and a feeder terminal 100; two side plates 2 including a second vibrator and a second housing for coating the second vibrator; and a rotating mechanism which is designed to connect the main body 1 and the side plate 2 and to rotate the side plate 2 around the main body 1. The first vibrator is in electric connection with the second vibrator at the rotating mechanism. The main body 1 is connected to the side plate 2 through the rotating mechanism so that the side plate 2 can rotate around the main body 1.

In the present embodiment, the side plate 2 is configured with two side plates, which are symmetrically distributed on both sides of the main body 1, so that the television can receive signals well by rotating the two side plates 2, without the need to move the main body 1 of the panel antenna, to right face the source of the television signal to be received to make the receiving surface larger. In addition, the VHF signal can be better received as a large width exists between the two side plates 2 and the main body 1 of the panel antenna.

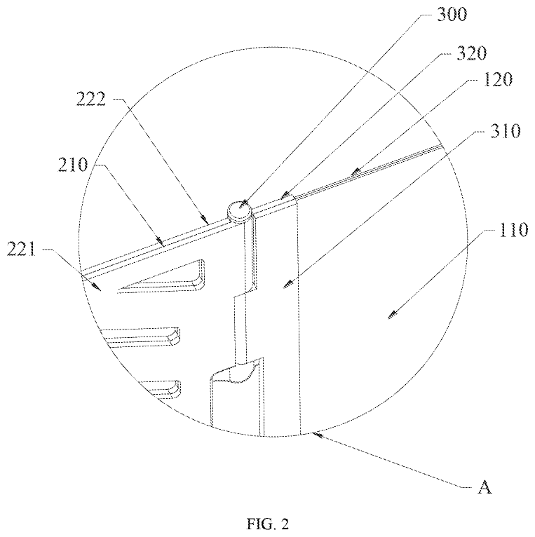

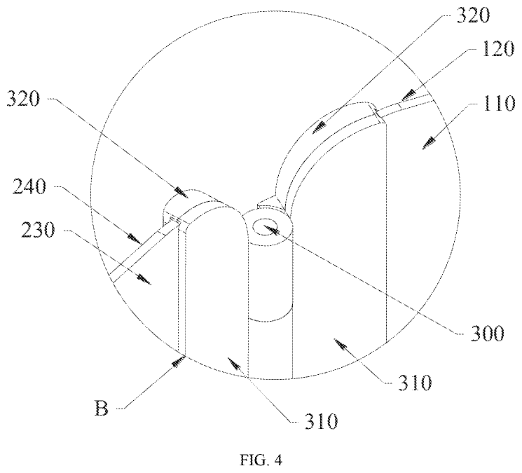

As shown in FIG. 2 and FIG. 4, in the present embodiment, the first housing has a double-layer panel structure, which is divided into a first front housing 110 and a first rear housing 120. The first vibrator is clamped in the interlayer formed by the first front housing 110 and the first rear housing 120. The second housing has a double-groove structure including a groove base 210 provided with a front groove and a rear groove, a front cover plate 221 and a rear cover plate 222. The second vibrator is divided into a second front vibrator and a second rear vibrator. The second front vibrator is clamped in the interlayer formed by the front groove and the front cover plate 221, and the second rear vibrator is clamped in the interlayer formed by the rear groove and the rear cover plate 222. Therefore, both sides of the side plate 2 can receive signals. When one surface of the active page of the panel antenna cannot receive signals due to a fault, or the signal reception is poor, such surface can be removed and the other surface without a fault can be installed and used by rotating 180°, thus further improving the utilization of the panel antenna.

As shown in FIG. 1, the second housing in the present embodiment only coats the second vibrator outside in form of a grid structure. Since the active vibrator or passive vibrator for the panel antenna to receive signal are generally configured into a plurality of strip structures in parallel arrangement, which refers to the principle of Yagi panel antenna, the panel antenna in the present embodiment only coats the housing at the active vibrator or the passive vibrator to form a grid structure, which can save material and cost and reduce the weight of the panel antenna itself, making it lighter and more convenience to transport and carry.

In the present embodiment, the rotating mechanism is detachable. The main body 1 is in electric connection with the side plate 2. As shown in FIG. 2 and FIG. 4, the rotating mechanism includes a shaft 300 and a plurality of bearings arranged on the main body 1 and the side plate 2. The bearings are preferably sleeved on the shaft 300 to realize rotation. The rotating mechanism further includes a limit mechanism which can adjust an angle of the side plate 2 relative to the main body 1 within 0° to 180°.

The side plate 2 and the main body 1 are detachably connected, and can be directly assembled when used, and the side plate 2 can be removed when not in use, making it more convenience to transport and carry. In addition, the active page of the side plate 2 of the antenna can be directly replaced when it needs to be repaired due to a fault without repair for the entire antenna. The rotating mechanism connecting the side plate 2 and the main body 1 is further provided with a limit mechanism for limiting the rotation angle of the side plate 2. The angle is set according to the preferred effect range of the received signal of the antenna, and is generally set between 0° and 180°. Further, the configuration of the limit mechanism can also prevent the side plates 2 from rotating sharply, which may shorten service life of the antenna.

In the present embodiment, the bearings on the side plate 2 are symmetrically distributed, and the side plate 2 has a symmetric structure for being replaced by the other side and guaranteeing that the receiving signals are maintained to have the same stability as before when replaced by the other side.

In the present embodiment, the electrical connection mode between the main body 1 and the side plate 2 can be a flexible flat-cable connection. A gap exists between the bearings, so that the flexible flat-cable crosses the shaft 300 to realize electrical connection between the main body 1 and the side plate 2.

In the present embodiment, the bearing has a bearing seat, and the bearing seat is divided into a front bearing seat 310 and a rear bearing seat 320. The bearing seat is L-shaped, and the front bearing seat 310 and the rear bearing seat 320 are used for clamping the first front housing 110 and the first rear housing 120. Alternatively, the bearing seat is I-shaped, and the front bearing seat 310 and the rear bearing seat 320 are used for clamping the second front housing and the second rear housing.

### Embodiment 2

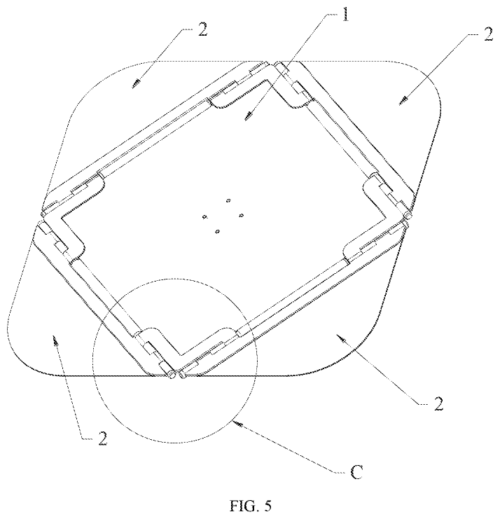

As shown in FIG. 5, the embodiment provides a foldable panel antenna with four side plates 2. The panel antenna comprises a main body 1 including a first vibrator, a first housing coating the first vibrator, and a feeder terminal 100; the side plate 2 including a second vibrator and a second housing coating the second vibrator; and a rotating mechanism which is designed to connect the main body 1 and the side plate 2 and rotate the side plate 2 around the main body 1. The first vibrator is in electric connection with the second vibrator at the rotating mechanism, and the main body 1 is connected to the side plate 2 through the rotating mechanism so that the side plate 2 can rotate around the main body 1.

In the embodiment, the main body is in a square shape. The four side plates 2 are distributed in a center symmetric structure around the main body 1. Each side plate is connected to the main body through a rotating mechanism, so that the angles of the side plate 2 of the panel antenna can be adjusted in multiple directions, thereby obtaining more signals in different directions, so as to achieve optimal combination of the signal sources, and finally realizing the enhancement and optimization of the panel antenna signal.

The first housing and the second housing both have double-layer panel structures. The first housing is divided into a first front housing 110 and a first rear housing 120. The first vibrator is clamped in the interlayer formed by the first front housing 110 and the first rear housing 120. The second housing is divided into a second front housing 230 and a second rear housing 240. The second vibrator is clamped in the interlayer formed by the second front housing 230 and the second rear housing 240. The first housing and the second housing are both configured with double-layer panel structures, and the first vibrator and the second vibrator are respectively clamped in the interlayers of the first housing and the second housing, so that the whole panel antenna has small size, thin thickness, and light weight, is convenient to transport and install, and takes less transportation cost.

In the embodiment, the area of the main body 1 is greater than or equal to a sum of areas of the side plate 2. The four side plates 2 are in triangle with different shape. The area of each side plate 2 is less than or equal to a quarter of the area of the main body 1, and the side plate 2 cannot overlap with one another when folded. When needs to be stored, the side plate 2 is folded up. Each side plate 2 will not overlap and not exceed the size of the main body 1, making it more convenient to carry and more aesthetic quality.

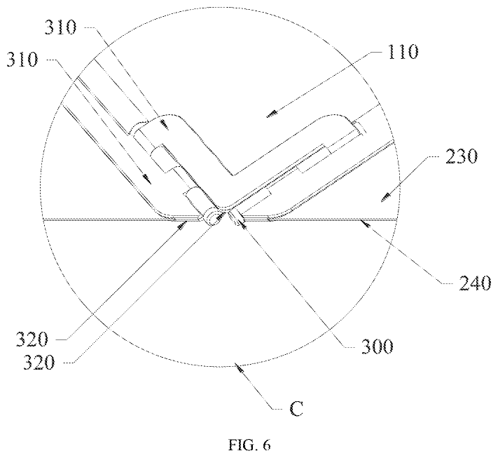

In the embodiment, the rotating mechanism is detachable. The main body 1 is in electric connection with the side plate 2. As shown in FIG. 6, the rotating mechanism includes a shaft 300 and a plurality of bearings arranged on the main body 1 and the side plate 2. The bearings are sleeved on the shaft 300 to realize rotation. The rotating mechanism further includes a limit mechanism which can adjust an angle of the side plate 2 relative to the main body 1 within 0° to 180°.

The side plate 2 and the main body 1 are detachably connected, and can be directly assembled when in use, and the side plate 2 can be removed when not in use, making it more convenient to transport and carry. In addition, active page of the side plate 2 of the antenna can be directly replaced when it needs to be repaired due to a fault without repair for the entire antenna. The rotating mechanism connecting the side plate 2 and the main body 1 is further provided with a limit mechanism for limiting the rotation angle of the side plate 2. The angle is set according to the preferred effect range of the received signal of the antenna, and is generally set between 0° and 180°. Further, the configuration of the limit mechanism can also prevent the side plates 2 from rotating sharply, which may shorten service life of the antenna.

In the embodiment, the first housing and the second housing are molded using a PET film.

In the embodiment, the bearing has a bearing seat, and the bearing seat is divided into a front bearing seat 310 and a rear bearing seat 320. The bearing seat is L-shaped, and the front bearing seat 310 and the rear bearing seat 320 are used for clamping the first front housing 110 and the first rear housing 120. Alternatively, the bearing seat is I-shaped, and the front bearing seat 310 and the rear bearing seat 320 are used for clamping the second front housing 230 and the second rear housing 240.

Obviously, the above embodiments of the present invention are merely examples for clear illustration, and are not intended to limit the implementations of the present invention. Any modification, equivalent substitution or improvement, and the like within the spirit and principle of the present invention should be included in the scope of claims of the present invention.

1. A foldable panel antenna, comprising:
a main body including
a first vibrator,
a first housing coating the first vibrator, and
a feeder terminal;
at least one side plate including
a second vibrator and
a second housing coating the second vibrator; and
a rotating mechanism which is designed to connect the main body and the side plate and to rotate the side plate around the main body, and the first vibrator is in electric connection with the second vibrator at the rotating mechanism.

2. The foldable panel antenna according to claim 1, wherein the side plate is configured with two which are asymmetrically distributed on both sides of the main body.

3. The foldable panel antenna according to claim 1, wherein the main body is a rectangular shape, circular shape or centrally symmetric polygon, and the side plate is configured more than one, which are centrosymmetrically distributed around the main body.

4. The foldable panel antenna according to claim 1, wherein the first housing and the second housing both have double-layer panel structures, the first housing is divided into a first front housing and a first rear housing, the first vibrator is clamped in an interlayer formed by the first front housing and the first rear housing; the second housing is divided into a second front housing and a second rear housing, and the second vibrator is clamped in an interlayer formed by the second front housing and the second rear housing.

5. The foldable panel antenna according to claim 1, wherein the first housing has a double-layer panel structure, the first housing is divided into a first front housing and a first rear housing, the first vibrator is clamped in an interlayer formed by the first front housing and the first rear housing; the second housing has a groove structure including a groove base and a cover plate, and the second vibrator is clamped in an interlayer formed by the groove base and the cover plate.

6. The foldable panel antenna according to claim 1, wherein the first housing has a double-layer panel structure, the first housing is divided into a first front housing and a first rear housing, the first vibrator is clamped in an interlayer formed by the first front housing and the first rear housing; the second housing has a double-groove structure including a groove base, a front cover plate and a rear cover plate, and the groove base is provided with a front groove and a rear groove, the second vibrator is divided into a second front vibrator and a second rear vibrator, the second front vibrator is clamped in an interlayer formed by the front groove and the front cover plate, and the second rear vibrator is clamped in an interlayer formed by the rear groove and the rear cover plate.

7. The foldable panel antenna according to claim 3, wherein an area of the main body is greater than or equal to a sum of areas of the side plate; the side plate is configured with four and an area of each side plate is less than or equal to a quarter of the area of the main body, and the side plate do not overlap with one another when folded.

8. The foldable panel antenna according to claim 2, wherein the second housing only coats the second vibrator in form of a grid structure.

9. The foldable panel antenna according to claim 1, wherein the rotating mechanism is detachable, the main body is in electric connection with the side plate, the rotating mechanism includes a shaft and a plurality of bearings provided on the main body and the side plate, the bearings are sleeved through the shaft to realize rotation, and the rotating mechanism further includes a limit mechanism which can adjust an angle of the side plate relative to the main body within 0° to 180°.

10. The foldable panel antenna according to claim 9, wherein the bearings on the side plate are symmetrically distributed, and the side plate is in a symmetric structure.
